(19) United States
(12) Patent Application Publication
(10) Pub. No.: US 2009/0123811 A1
(43) Pub. Date: May 14, 2009

(54) ELECTROCHEMICAL CELL AND FUEL CELL INCLUDING IT

(76) Inventors: Frank BAUMANN, Mundelsheim (DE); Sebastian Maass, Stuttgart (DE); Jens Intorp, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/269,403

(22) Filed: Nov. 12, 2008

(30) Foreign Application Priority Data
Nov. 13, 2007 (DE) 10 2007 054 098.3

(51) Int. Cl. H01M 2/02

(52) U.S. Cl. 429/34

(57) ABSTRACT

An electrochemical cell for extraction of electrical energy is described, which includes a first gas chamber provided with a first gas feeder for a first gas, in which chamber a first electrode is positioned. The cell includes a second gas chamber provided with a further gas feeder for a second gas, in which chamber a second electrode is positioned. The first and second gas chambers are in ion-conducting contact via a diaphragm, and the first and second electrodes form an anode and cathode, respectively, of the electrochemical cell. The first electrode functioning as an anode, the diaphragm, the first gas chamber, and/or the first gas feeder contain an oxygen-storing material.

### BACKGROUND OF THE INVENTION

1. Field of the Invention

The present invention relates to an electrochemical cell for extraction of electrical energy, and to a fuel cell including it.

2. Description of the Prior Art

Fuel cells are effective systems for electrochemical conversion of chemical energy into electrical energy. Typically, they include a plurality of electrochemical cells, which in turn are each formed of one anode compartment and one cathode compartment. If suitably oxidizable or reducible substances are fed to these compartments, then these “substances are converted at the applicable anode and cathode of the electrochemical compartments, and a flow of electrical current results between the anode and the cathode of the electrochemical cell. In the partial-load or idling mode of such electrochemical cells, problems arise since the compartments experience local depletion of the chemical substances to be converted, causing possible irreversible damage.

For solving this problem, it is proposed for instance in German Patent Disclosure DE 101 55 217 A1 that during idling, the exhaust gases from a fuel cell be recirculated and resupplied to the corresponding compartments of the electrochemical cells. This prevents the buildup of water in the system.

### OBJECT AND SUMMARY OF THE INVENTION

The object of the present invention is to furnish an electrochemical cell and a fuel cell containing it which make partial-load and idling operation possible without causing damage to the electrochemical cell.

The electrochemical cell and the fuel cell containing it on which the invention is based advantageously attain the object of the invention.

This is due in particular to the fact that the electrochemical cell has an oxygen-storing material, for instance in the region of its electrodes, in the region of a diaphragm that separates the compartments of the electrochemical cell from one another, or in the region of the gas feeder to the compartments.

If a reducing gas, such as hydrogen, is fed to the anode compartment of the electrochemical cell to furnish electrical energy, and oxygen, for instance, is fed to the cathode compartment as a gaseous oxidant, then in electrochemical cells of conventional design, in partial-load or idling operation, local depletion of hydrogen in the anode compartment can occur. This presents the risk of damage to the anode compartment from oxygen that diffuses into the anode compartment from the cathode compartment via a diaphragm that separates the two compartments of the electrochemical cell.

If an oxygen-storing material is provided in the region of the electrochemical cell that is exposed to the risk of damage, then oxygen diffusing in can be reversibly bound chemically, and damage to the corresponding anode compartment of the electrochemical cell can be prevented. Introducing an oxygen-storing material into the materials from which the anode compartment, or its periphery, is made is a comparatively simple provision, compared to recirculating hydrogen-containing exhaust gases of the fuel cell.

It is accordingly advantageous if an oxide of any of cerium, vanadium, niobium, chromium, molybdenum, manganese, iron, cobalt, or nickel is used as the oxygen-storing material. The elements bound in the oxides have as a common property the fact that they form stable oxides in at least two oxidation stages and thus are available for reversible storage of oxygen. Moreover, because of their redox potentials, they can be oxidized by oxygen on the one hand, which is equivalent to a storage operation of diffusing oxygen, and on the other, they can be reduced by a hydrogen excess, which schematically is equivalent to taking oxygen out of storage.

It is also advantageous if the oxygen-storing material is additionally doped with a noble metal or a rare earths element. This is based on the recognition that noble metals and elements of the rare earths have a catalytic activity with regard to redox reactions and thus catalyze the storage of oxygen in the oxygen-storing material or the removal of oxygen from storage in that material and lead to a largely complete removal of oxygen from the material that is exposed to possible damage. The oxygen-storing material, for instance in the form of dispersed particles, is integrated with one of the materials from which the anode compartment is formed. In particular, it is advantageous if the oxygen-storing material is provided in the form of nanoparticles, since because of their high surface area they make effective oxygen storage possible.

In a further advantageous embodiment, the oxygen-storing material is a mono- or multivalent alcohol or a ketone. These substances are suitable in particular as oxygen reservoirs in an organic matrix, of the kind that is represented for instance by a diaphragm that separates the two electrochemical compartments. They too are distinguished by an oxygen storage capability that is based on their reversible oxidizability.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically shows the electrochemical processes that take place at a diaphragm of an electrochemical cell and also plots the electrode potentials that occur in the process; and

FIG. 2 is a schematic sectional view through an electrochemical cell in one embodiment of the present invention.

### DESCRIPTION OF THE PREFERRED EMBODIMENTS

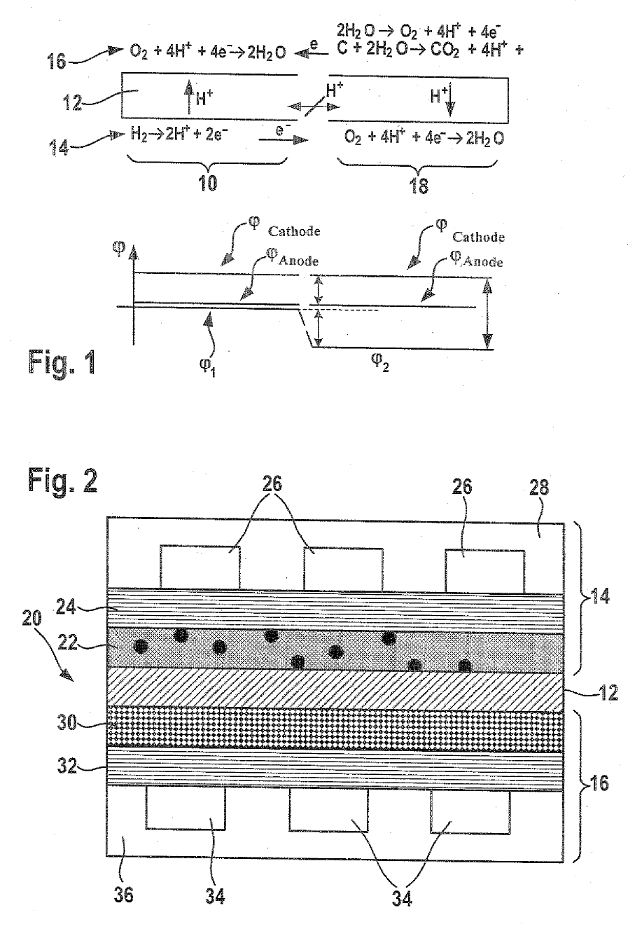

In FIG. 1, the chemical processes that take place at a diaphragm or in the electrochemical semicompartments of an electrochemical cell are shown in further detail. Reference numeral 10 indicates a portion of a diaphragm 12 in which there is an adequate supply of reactants for electrochemical extraction of electrical energy. For instance, hydrogen is fed to an anode compartment 14 and is electrochemically oxidized there; the electrons released in the process are fed via an electrical energy reservoir or consumer to a cathode compartment 16. The protons also released likewise diffuse into the cathode compartment 16 via the diaphragm 12. The cathode compartment 16 in its turn is fed with oxygen, which with protons that are diffused in and by accepting a suitable number of electrons reacts to form water.

In the partial-load or idling mode of an electrochemical cell of this kind, the supply of reactants is typically throttled or stopped. Thus local depletion of hydrogen in the anode compartment 14 can occur. The consequence is that oxygen diffuses from the cathode side to the anode side of the diaphragm 12 and at the anode of the anode compartment 14 reacts with protons, accepting electrons, to form water. In this way, the diaphragm 12 is depleted of protons in this region, and the diaphragm potential Φᵢ drops to a level Φ₂. Since the diaphragm potential Φ₁ and Φ₂ simultaneously represents the reference potential of the electrochemical electrode potentials Φ_{anode} and Φ_{cathode} of the cathode and anode, respectively, the electrochemical potential Φ_{cathode} and Φ_{anode} increases accordingly. This is especially critical for the cathode of the electrochemical cell, since in the normal operating state this cathode already has a higher operating potential. If the potential Φ_{cathode} rises past a value of approximately 0.2 Volts, there is the risk of damage or deactivation or destruction of the cathode of the electrochemical cells, for instance from oxidation of the carbon bound in them to form carbon dioxide. This kind of proton-depleted region of the diaphragm 12 is identified as an example by reference numeral 18 in FIG. 1.

Because of the poor transverse conductivity of the diaphragm 12, the proton deficiency can be compensated or locally only extremely poorly by transverse diffusion of protons. In order nevertheless to counteract local damage, particularly to the cathode, according to the invention an oxygen-storing material is provided, especially in the region of the anode compartment 14.

An electrochemical cell in an embodiment of the present invention has the schematic structure shown in FIG. 2, for instance. Identical reference numerals identify the same components as in FIG. 1.

Thus besides a diaphragm 12, the electrochemical cell 20 also has an anode catalyst layer 22 inside the anode compartment 14; this layer functions as an anode and serves the purpose of electrochemical conversion of the reactants fed to the anode compartment 14. For simultaneously distributing the reactants, which in particular are in gaseous form, the anode compartment 14 further includes a first gas distributor layer 24 and at least one first gas feeder 26. The at least one gas feeder 26 is integrated for instance with a so-called bipolar plate 28, which serves the purpose of electrical contacting and connection of the electrochemical cell 20 in series with other electrochemical cells, not shown.

The electrochemical cell 20, in the region of its cathode compartment 16, further includes a cathode catalyst layer 30, which functions as a cathode and serves the purpose of electrochemical conversion of the reactants, acting as oxidants, that are fed by the cathode compartment 16. To assure a uniform distribution of the reactants, which in particular are gaseous, inside the cathode compartment 16, the cathode compartment 16 further includes a further gas distributor layer 32. It is in contact with at least one further gas feeder 34, which serves to feed gaseous reactants to the cathode compartment 16, and the further gas feeder 34, for instance, is integrated with a further bipolar plate 36.

To protect against damage during a possible partial-load or idling mode of the electrochemical cell, the electrochemical cell 20, particularly in the region of the anode compartment 14, includes at least one oxygen-storing material 40. The oxygen-storing material 40 can be incorporated into the material of the anode catalyst layer 22, for instance, in the form of dispersed particles, preferably nanoparticles. In this way, oxygen that has diffused in from the cathode side is bound before it can react with protons in the region of the anode catalyst layer 22.

As the oxygen-storing material 40, oxides are suitable, in particular of transition metal materials which form thermodynamically stable oxides in at least two oxidation stages and can be reversibly converted into oxidants or reducing agents by the action of a corresponding oxidant or reducing agent. For instance, transition metal oxides of cerium, vanadium, niobium, chromium, molybdenum, manganese, iron, cobalt, or nickel are suitable. The processes occurring upon oxygen storage are reflected in formula 1, for example:

Ce₂O₃+½O₂−>2CeO₂ (1)

If the anode compartment 14 of the electrochemical cell 20 is again sufficiently supplied with hydrogen, for instance upon resumption of operation of the electrochemical cell 20, then the oxygen-storing component, converted into its oxidized form, is again converted to its reduced form, releasing water. The processes taking place then are reflected in formula 2 as an example.

2CeO₂+H₂−>Ce₂O₃+H₂O (2)

As an alternative or in addition, the oxygen-storing material may also be provided in the gas distributor layer 24, as well as in both the at least one first gas feeder 26 and the diaphragm 12. Moreover, it is possible to introduce the oxygen-storing material in the form of a separate layer, for instance between the anode catalyst layer 22 and the first gas distributor layer 24, or between the first gas distributor layer 24 and the bipolar plate 26.

Since the diaphragm 12 in particular is typically made from an organic polymer, the use of organic oxygen-storing materials can be especially attractive in this region as an alternative or in addition. Monovalent or multivalent alcohols in particular, such as glycols, or a glycerin or ketone are suitable for the purpose. They may be incorporated in the form of an emulsion into the diaphragm during the production of the polymer diaphragm 12, or the polymer materials of the diaphragm 12 are functionalized, for instance at their side chains, with a suitable alcohol or ketone function.

For extraction of electrical energy, a plurality of electrochemical cells 20 are for instance combined into a so-called fuel cell stack. This stack, together with suitable peripheral components, forms a fuel cell. Using a fuel cell of this kind can be considered, for instance in the mobile field but also in the stationary field of household heating systems and in the power plant field.

The foregoing relates to preferred exemplary embodiments of the invention, it being understood that other variants and embodiments thereof are possible within the spirit and scope of the invention, the latter being defined by the appended claims.

We claim:

1. An electrochemical cell for extraction of electrical energy, comprising:
a first gas chamber provided with a first gas feeder for a first gas, in which first gas chamber a first electrode is positioned;
a second gas chamber provided with a second gas feeder for a second gas, in which second gas chamber a second electrode is positioned, the first and second electrodes forming an anode and cathode, respectively, of the electrochemical cell; and
a diaphragm being in ion-conducting contact with the first and second gas chambers, wherein
the first electrode functioning as an anode, the diaphragm, the first gas chamber, and/or the first gas feeder contain an oxygen-storing material.

2. The electrochemical cell as defined by claim 1, wherein the oxygen-storing material is an oxide of cerium, vanadium, niobium, chromium, molybdenum, manganese, iron, cobalt, or nickel.

3. The electrochemical cell as defined by claim 2, wherein the oxygen-storing material is doped with a noble metal or a rare earth element.

4. The electrochemical cell as defined by claim 1, wherein the oxygen-storing material is introduced, in a form of dispersed particles, into a matrix of a material comprising the first electrode or the diaphragm.

5. The electrochemical cell as defined by claim 2, wherein the oxygen-storing material is introduced, in a form of dispersed particles, into a matrix of a material comprising the first electrode or the diaphragm.

6. The electrochemical cell as defined by claim 3, wherein the oxygen-storing material is introduced, in a for of dispersed particles, into a matrix of a material comprising the first electrode or the diaphragm.

7. The electrochemical cell as defined by claim 1, wherein the oxygen-storing material is provided in the form of nanoparticles.

8. The electrochemical cell as defined by claim 2, wherein the oxygen-storing material is provided in the form of nanoparticles.

9. The electrochemical cell as defined by claim 3, wherein the oxygen-storing material is provided in the form of nanoparticles.

10. The electrochemical cell as defined by claim 6, wherein the oxygen-storing material is provided in the form of nanoparticles.

11. The electrochemical cell as defined by claim 1, wherein the first gas feeder is a hydrogen feeder.

12. The electrochemical cell as defined by claim 2, wherein the first gas feeder is a hydrogen feeder.

13. The electrochemical cell as defined by claim 3, wherein the first gas feeder is a hydrogen feeder.

14. The electrochemical cell as defined by claim 10, wherein the first gas feeder is a hydrogen feeder.

15. The electrochemical cell as defined by claim 1, wherein the first gas chamber is formed by a gas distributor layer.

16. The electrochemical cell as defined by claim 2, wherein the first gas chamber is formed by a gas distributor layer.

17. The electrochemical cell as defined by claim 14, wherein the first gas chamber is formed by a gas distributor layer.

18. The electrochemical cell as defined by claim 15, wherein the oxygen-storing material is a mono- or multivalent alcohol, contained in the material of the diaphragm, or a ketone.

19. A fuel cell including at least two electrochemical cells as defined claim 1, wherein the at least two electrochemical cells are electrically in contact with one another via at least one bipolar plate.

20. The fuel cell as defined by claim 19, wherein the first and the second gas feeder are each integrated with a respective further bipolar plate.
